(19) United States
(12) Patent Application Publication
(10) Pub. No.: US 2006/0195484 A1
(43) Pub. Date: Aug. 31, 2006

(54) System and method for providing a dynamic user interface for workflow in hospitals

(75) Inventors: Prakash Mahesh, Schaumburg, IL (US); Mark M. Morita, Arlington Heights, IL (US); Thomas A. Gentles, Algonquin, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/067,192

(22) Filed: Feb. 25, 2005

(51) Int. Cl. G06F 17/30

(52) U.S. Cl. 707/200

(57) ABSTRACT

Certain embodiments of the present invention provide a method and system for improved management of multiple applications and workflows using a workflow engine based dynamic worklist in a healthcare environment. In an embodiment, the system includes at least one data store, wherein the at least one data store includes departmental and/or enterprise information. The system also includes a plurality of databases, wherein the plurality of databases includes user tasks, user rules, and user preferences. In addition, the system includes a workflow engine for calculating and filtering the information obtained from the databases and data stores. The system also includes a worklist user interface, wherein the information calculated and filtered by the workflow engine is displayed.

### BACKGROUND OF THE INVENTION

The present invention generally relates to a workflow engine based dynamic worklist in a healthcare environment. In particular, the present invention relates to a system and method for providing rules, tasks and preference-based dynamic user interface for departmental and enterprise workflow in a healthcare environment.

A clinical or healthcare environment is a crowded, demanding environment. Thus, a system and method providing improved organization and improved ease of use of imaging systems, data storage systems, and other equipment used in the healthcare environment would be highly desirable. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with job performance. Furthermore, workspaces, such as a radiology workspace, may become cluttered with a variety of monitors, data input devices, data storage devices, and communication devices, for example. Cluttered workspaces may result in inefficient workflow and service to clients, which may impact a patient's health and safety or result in liability for a healthcare facility. Data entry and access is also complicated in a typical healthcare facility.

Thus, management of multiple and disparate devices, positioned within an already crowded environment, that are used to perform daily tasks is difficult for medical or healthcare personnel. Additionally, a lack of interoperability between the devices increases delay and inconvenience associated with the use of multiple devices in a healthcare workflow. The use of multiple devices may also involve managing multiple logons within the same environment. A system and method for improving ease of use and interoperability between multiple devices in a healthcare environment would be highly desirable.

In a healthcare environment involving extensive interaction with a plurality of devices, such as keyboards, computer mousing devices, imaging probes, and surgical equipment, repetitive motion disorders often occur. A system and method that eliminate some of the repetitive motion in order to minimize repetitive motion injuries would be highly desirable.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

In current information systems, such as PACS, information is entered or retrieved using a local computer terminal with a keyboard and/or mouse. During a medical procedure or at other times in a medical workflow, physical use of a keyboard, mouse or similar device may be impractical (e.g., in a different room) and/or unsanitary (i.e., a violation of the integrity of an individual's sterile field). Re-sterilizing after using a local computer terminal is often impractical for medical personnel in an operating room, for example, and may discourage medical personnel from accessing medical information systems. Thus, a system and method providing access to a medical information system without physical contact would be highly desirable to improve workflow and maintain a sterile field.

Imaging systems are complicated to configure and to operate. Often, healthcare personnel may be trying to obtain an image of a patient, reference or update patient records or diagnosis, and ordering additional tests or consultation. Thus, there is a need for a system and method that facilitate operation and interoperability of an imaging system and related devices by an operator.

In many situations, an operator of an imaging system may experience difficulty when scanning a patient or other object using an imaging system console. For example, using an imaging system, such as an ultrasound imaging system, for upper and lower extremity exams, compression exams, carotid exams, neo-natal head exams, and portable exams may be difficult with a typical system control console. An operator may not be able to physically reach both the console and a location to be scanned. Additionally, an operator may not be able to adjust a patient being scanned and operate the system at the console simultaneously. An operator may be unable to reach a telephone or a computer terminal to access information or order tests or consultation. Providing an additional operator or assistant to assist with examination may increase cost of the examination and may produce errors or unusable data due to miscommunication between the operator and the assistant. Thus, a method and system that facilitate operation of an imaging system and related services by an individual operator would be highly desirable.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Currently, a practitioner must log on to different systems and search for a patient to retrieve information from the system on that patient. For example, if a patient complains of chest pain, a chest x-ray is taken. Then the radiologist logs on to other systems to search for the patient and look for specific conditions and symptoms for the patient. Thus, the radiologist may be presented with a large amount of information to review.

Depending upon vendors and systems used by a practitioner, practitioners, such as radiologists or cardiologists, have only a few options to reference the tools available. First, a request for information from the available tools may be made in paper form. Second, a practitioner may use different applications, such as a radiologist information system (RIS), picture archiving and communication system (PACS), electronic medical record (EMR), healthcare information system (HIS), and laboratory information system (LIS), to search for patients and examine the information electronically.

In the first case, the practitioner shifts his or her focus away from a reading workstation to search and browse through the paper, which in most cases includes many pieces of paper per patient. This slows down the practitioner and introduces a potential for errors due to the sheer volume of paper. Thus, a system and method that reduce the amount of paper being viewed and arranged by a practitioner would be highly desirable.

In the second case, electronic information systems often do not communicate well across different systems. Therefore, the practitioner must log on to each system separately and search for the patients and exams on each system. Such a tedious task results in significant delays and potential errors. Thus, a system and method that improve communication and interaction between multiple electronic information systems would be highly desirable.

Additionally, even if systems are integrated using mechanisms such as Clinical Context Object Workgroup (CCOW) to provide a practitioner with a uniform patient context in several systems, the practitioner is still provided with too much information to browse through. Too much information from different applications is provided at the same time and slows down the reading and analysis process. There is a need to filter out application components that a user will not need in a routine workflow. Thus, a system and method which manage information provided by multiple systems would be highly desirable.

Furthermore, if a technologist is performing a radiology or cardiology procedure, for example, the technologist typically accesses multiple applications to obtain information prior to the procedure. In a digital environment, information resides in a plurality of disparate systems, such as a RIS and a PACS. Currently, the technologist must access each system and search for the information by clicking many tabs and buttons before having access to all of the information needed to start the procedure. Often, such an effort by a technologist to obtain information for a procedure results in a decrease in productivity due to the time involve and/or a decrease in information quality due to the time involved to do a thorough search. Thus, a system and method which improve searchability and access to data would be highly desirable.

Additionally, referring physicians use many computerized applications for patient care. In radiology, a physician may look at information from RIS, PACS, EMR, and Computer Physician Order Entry (CPOE), for example. The referring physician typically accesses multiple applications to get all of the information needed before, during and/or after the patient consult and follow-up. For example, in a digital environment, the referring doctor refers to a RIS for results from a current procedure, prior procedures, and/or a web-based image viewer, such as a PACS, for viewing any current and prior images. The doctor may access a CPOE to order any follow-up exams. The referring physician opens the RIS, PACS, and CPOE to search for the information by clicking many tabs and buttons before having access to the information. Thus, there is a need for a system and method which improve searchability and access to data.

Thus, there is a need for a system and method to improve management of multiple applications and workflows using a workflow engine based dynamic worklist in a healthcare environment.

### BRIEF SUMMARY OF THE INVENTION

Certain embodiments of the present invention provide a method and system for improved management of multiple applications and workflows using a workflow engine-based dynamic worklist in a healthcare environment. In an embodiment, the dynamic worklist management system include at least one data store, which includes information. The system also includes a plurality of databases capable of storing user data. In addition, the system includes a worklist user interface, which includes a task list. The system also includes a workflow engine for dynamically updating the task list on the worklist user interface using the user data provided in the plurality of databases and/or information in the at least one data store.

The system may also include an authentication module for authenticating access to the worklist user interface. In an embodiment, the worklist user interface includes at least one button and/or link to access information in an independent application. The system may access at least one external system. The plurality of databases may also include a user tasks database, a user rules database, and a user preferences database. The at least one data store may also include a departmental data store and an enterprise data store. In an embodiment, the workflow engine monitors and dynamically updates the worklist user interface with user data from the plurality of databases and/or information from the at least one data store.

Certain embodiments of a method for dynamically updating a worklist user interface include dynamically identifying at least one task, filtering and organizing the at least one task, displaying the at least one task, providing information based on a user selection, and updating the at least one task based on a user selection. The method may also include authenticating access to the information. The method may also include accessing information form a plurality of sources including departmental, enterprise, and/or external information sources.

In an embodiment, the process of identifying, filtering, and displaying the at least one task is dynamic. At least one rule may be used to filter the at least one task. At least one user preference may be used to organize the at least one task. The at least one rule may be dynamically created or modified. The at least one preference may be dynamically created or modified.

Certain embodiments of a computer-readable storage medium include a set of instructions for a computer. In certain embodiments, the set of instructions include a user action routine for updating stored information based on user selections in a worklist user interface. The set of instructions also include a user task routine for identifying user tasks based on dynamically updating stored information. In addition, the set of instructions include a workflow engine routine for filtering the user tasks identified by the identification routine. The set of instructions also include a worklist routine for displaying the filtered user tasks on the worklist user interface.

In an embodiment, the set of instructions may also include a user rules engine routine for defining rules for filtering user tasks. In addition, the set of instructions may also include a user preferences engine routine for defining preferences for filtering user tasks. The set of instructions may also include a perspectives routine for organizing the information for a user.

### BRIEF DESCRIPTION OF SEVERAL VIEWS OF THE DRAWINGS

FIG. 1 illustrates a rules, tasks, and preference-based dynamic worklist management system used in accordance with an embodiment of the present invention.

FIG. 2 illustrates a flow diagram for a method for improved workflow using a rules, tasks, and preference-based dynamic worklist management system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

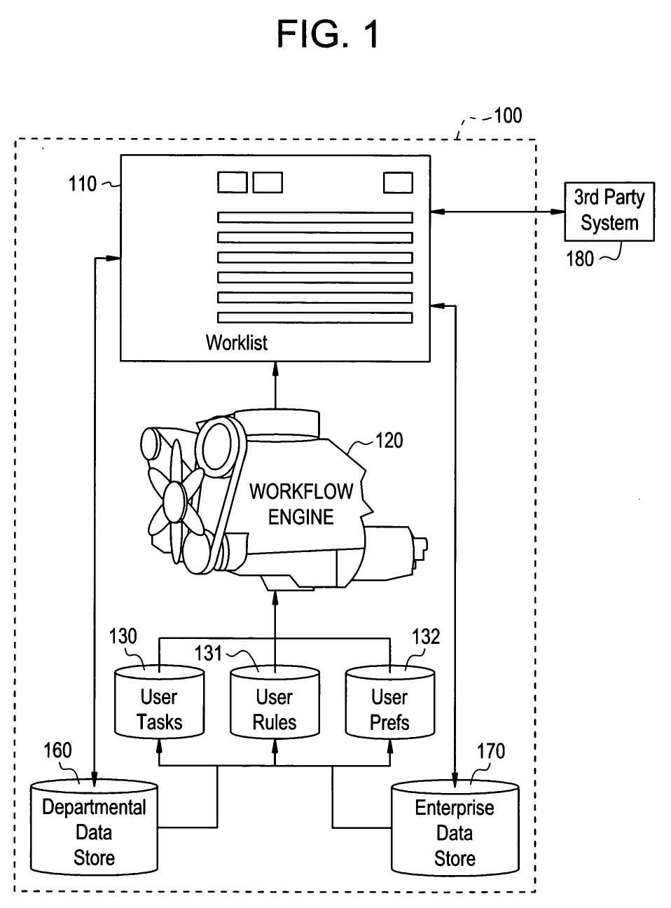

FIG. 1 illustrates a dynamic worklist management system 100 used in accordance with an embodiment of the present invention. The system 100 includes a worklist user interface 110, a workflow engine 120, a plurality of databases 130, 131, 132, and at least one data store 160, 170. Databases 130-132 may include a user task database 130, a user rules database 131, and a user preferences database 132. Data stores 160, 170, may include a departmental data store 160, and an enterprise data store 170. The components of the system 100 may communicate via wired and/or wireless connections on one or more processing units, such as computers, medical systems, storage devices, custom processors, and/or other processing units. The system 100 may be implemented in software and/or hardware. In an embodiment, the dynamic worklist management system 100 is able to communicate with external third party systems 180. In an embodiment, the components of the system 100 are integrated into a single unit, or may be integrated in various forms.

The system 100 may be used to provide an integrated solution for application execution and/or information retrieval based on tasks, rules, and/or preferences in a shared environment. For example, tasks, rules, and/or preferences may be defined dynamically and/or loaded from a library or other data store to enable the workflow engine 120 to filter and/or process information generated from a departmental data store 160 and/or an enterprise data store 170. A shared environment is one in which the information in the databases 130-132 and data stores 160, 170 are available to all the users, subject to any constraints imposed by a system manager. In an embodiment, a system manager may restrict information accessible to users by using user IDs and passwords.

In an embodiment, the user task database 130 identifies tasks based on the workflow of the user and departmental information stored in the departmental data store 160 and/or enterprise information stored in the enterprise data store 170. For example, in a radiology department connected to a hospital, the user task database contains the workflow of the radiologists in that department. Radiologist workflow includes reading and interpreting various diagnostic x-rays and other imaging techniques such as ultrasound examinations, computerized tomography (CT) examinations, and magnetic resonance imaging (MRI) examinations. If an employee of the hospital schedules an ultrasound examination for a patient in the enterprise data store 170, the user task database 130 identifies the appointment using various information, such as the radiologist name, a particular examination, and/or the scheduled dates/times for the patient of a particular examination. The user task database 130 further identifies any information related to the particular patient that may assist the radiologist in performing the examination from the departmental data store 160. As the radiologist performs the ultrasound examination by selecting work items and acting upon work items in the worklist 110, the user task database 130 identifies the new information stored in the departmental 160 and/or enterprise 170 data stores and dynamically updates the information.

In an embodiment, a systems manager or user creates rules for the system, which are stored in the user rules database 131 and may relate to departmental and/or enterprise information stored in the data stores 160, 170. For example, in a radiology department of a hospital, a system administrator or user may create a rule stating Dr. Radiologist is responsible for all ultrasound exams on Mondays. The departmental rules set up by a systems manager or user are applied by the workflow engine 120 in filtering the information to be displayed on the worklist 110. Rules may be created based on time period, examination type, disease type, system type, etc. Rules may be predefined and/or created dynamically by the practitioner.

In an embodiment, rules may also be automatically generated and/or modified by the workflow engine 120 based on practitioner usage patterns and/or preferences, for example. The workflow engine 120 may save the workflow of the user as one or more perspectives so that there is no separate action to create the rules. One example of a perspectives management system is described in a U.S. Patent Application filed on Oct. 1, 2004, entitled “System and Method for Handling Multiple Radiology Applications and Workflows”, with inventors Prakash Mahesh and Mark Ricard, which is herein incorporated by reference in its entirety.

A user may also set rules for filtering information and images displayed via applications other than the worklist 110. One example of using a rules-based context management system is described in a U.S. Patent Application filed on Oct. 1, 2004, entitled “System and Method for Rules-Based Context Management in a Medical Environment”, with inventors Prakash Mahesh, Mark M. Morita, and Thomas A. Gentles, which is herein incorporated by reference in its entirety.

In an embodiment, a systems manager or user sets worklist display preferences, which are stored in the user preferences database 132 and may relate to departmental and/or enterprise information stored in the data stores 160, 170. For example, in a radiology department of a hospital, a system administrator or individual radiologist may set a preference stating for CT examinations, the worklist 110 automatically opens in dictation mode, launching the current and historical images for the current patient. The preferences set by a system administrator or user, which are stored in the user preference database 132, are utilized by the workflow engine 120 to filter the information displayed in the worklist 110. The ability of a system administrator or user to control how the information is displayed in the worklist 110, by adjusting the user preferences, improves the productivity and efficiency of a user in managing multiple applications and workflow.

In an embodiment, the workflow engine 120 is used to collect user tasks, user rules, and user preferences from the databases 130-132. The workflow engine 120 calculates and filters the data collected from the databases 130-132 and displays the information on the worklist 110. For example, as a radiologist performs an ultrasound examination by selecting work items and acting upon it in the worklist 110, the workflow engine 120 will dynamically update the worklist 110 by dynamically collecting, calculating, and filtering the updated information available in the user tasks 130, user rules 131, and user preferences 132 databases. The radiologist, by utilizing the dynamically updating worklist 110, is able to increase productivity by efficiently managing the workflow.

In an embodiment, the worklist 110 is a customizable user interface, such as a graphical or voice command user interface, which, among other things, allows a user to access components and features of the system 100 and acts as a slave to the workflow engine 120 by displaying the content fed by the workflow engine 120 and acting upon user actions. The content displayed in the worklist 110, referred to as workflow, may be in the form of a task list. The worklist 110 contains buttons or links that allow a user to access departmental information in the departmental data store 160, enterprise information in the enterprise data store 170, and/or information from third party systems 180. A radiologist, for example, performing an ultrasound examination is able to view what steps in the workflow have been completed and what steps in the workflow are pending. The worklist 110 includes buttons or links to information such as prior and related prior (historical) exams and their results, laboratory exams (such as blood work), allergies, pathology results, medication, alerts, and document images, to name a few. These buttons or links allow a radiologist to access a wide variety of information from several different applications using the worklist 110. The worklist 110 is customizable based on the user rules and user preferences entered by the user or system manager. The worklist 110 allows a user improved workflow and productivity by improving management of multiple applications and workflows.

In an embodiment, the information contained in a data store may be general information. For example, in a medical environment, general information may be hospital records (i.e. insurance information, scheduled exams, etc) and electronic medical records (EMR). General information contained in a data store may be stored in the enterprise data store 170. The information contained in a data store may also be department specific information. For example, in a medical environment, department specific information may be prior and related prior (historical) exams and results, laboratory exams (such as blood work), allergies, pathology results, medication, alerts, and document images. Department specific information may be stored in the departmental data store 160. Information in the data stores 160, 170 may be accessed through the worklist 110 if the information is linked to the worklist 110 or it may be accessed separately through other applications. The information stored in the data stores 160, 170 is also utilized in calculating the task list displayed in the worklist 110.

In an embodiment, the worklist 110 includes and/or communicates with an authentication unit. The authentication unit may include software and/or hardware to verify a user's right to access one or more of the databases 130-132 and/or departmental or enterprise information in the data stores 160, 170. In an embodiment, authentication via the worklist 110 allows access to relevant databases 130-132, data stores 160, 170, and other applications for a user. If a user logs on to a system running the worklist 110, user rules and user preferences may be created and saved in the user rules 131 and user preferences 132 databases to immediately access the user's preferred information from the departmental 160 and enterprise 170 data stores.

For example, a physician may prefer to look at labs, allergies and medication. Thus, a user rule can create a rule to provide links or buttons to access LIS and HIS for labs, allergies and medication when the physician logs onto the system 100, or to open and log onto the LIS and HIS applications separately from the worklist 110. Applications, such as LIS and HIS, display pertinent information for a patient. For example, the applications display all lab results for the patient for a specific date. The applications also display all complete blood count (CBC) data for the patient for the date. As another example, user rules may filter patient alert data for a specific date range and/or specific disease type. Thus, from the same workstation using the system 100, a user may link to RIS for relevant prior reports, link to PACS for relevant prior images, and/or elink to a LIS and/or HIS for specific information, all based on user rules created for accessing other systems/applications via the worklist 110. As a result, diagnosis and diagnostic reports may be reached more quickly and more accurately.

In operation, a user, such as a radiologist or cardiologist, accesses the RIS/PACS system via worklist 110 links, for example. RIS and PACS systems may be integrated into a single system, for example, with shared patient and exam contexts. Thus, the user access relevant prior history for a patient (e.g., images and reports). For example, the radiologist may log on to the RIS/PACS system which retrieves and integrates information from different systems based on an EMR number. Automatic login to one or more systems/applications may be accomplished by creating user rules to access such systems/applications.

Examples of non-medical environment applications include, but are not limited to: a test engineer may use the system 100 in product testing and development; an accountant may use the system 100 in doing financial planning or taxes for their customers, and; an attorney may use the system 100 in managing a case. In each of the above examples, the worklist 110 provides the workflow of the user as well as buttons and/or links to reports, schematics, graphs, charts, tax forms, stock information, budgets, legal briefs, exhibits, motions, orders, letters, and other related information, which would be found in a data store 160, 170. The user may set user rules and user preferences in the appropriate databases 131-132 so that the workflow engine 120 filters the information and displays the information to the user in the preferred manner on the worklist 110.

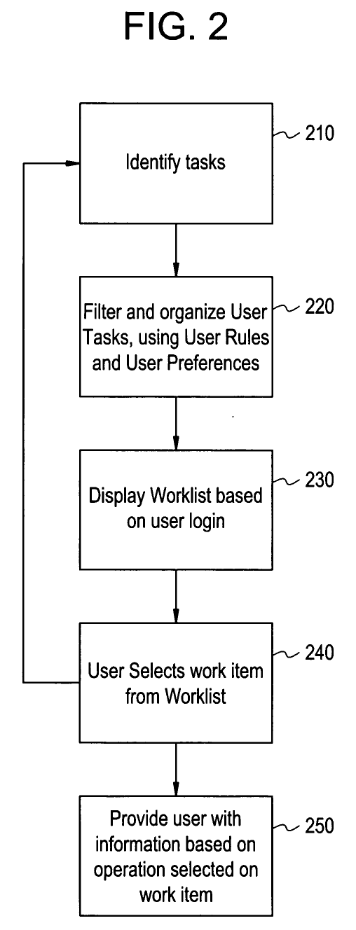

FIG. 2 illustrates a flow diagram for a method 200 for improved management of multiple applications and workflows using a workflow engine based dynamic worklist in accordance with an embodiment of the present invention.

First, at step 210, tasks are identified based on information such as the user names, the workflow of the users, and/or the scheduled dates/times or deadlines for the users. For example, tasks may be identified using the user tasks database 130 and information stored in the data stores 160, 170. The user tasks are defined by the workflow of the user. For example, if a patient scheduled an ultrasound exam, the user tasks database 130 will identify the scheduled appointment stored in the enterprise data store 170 as well as other relevant information the radiologist may need from the departmental 160 and/or enterprise 170 data stores, such as historical exams, blood work, allergies, medications, and other related patient information that may be stored in either the departmental 160 or enterprise 170 data stores.

At step 220, the user tasks, user rules, and user preferences are obtained from the respective databases 130-132 and are calculated and filtered by the workflow engine 120. The user rules may be defined for a particular user or group of users (e.g., surgeons, radiologists, cardiologists, etc.), for a particular use or group of uses (e.g., image-guided surgery, radiology reading, structured reporting, examination, etc.), and/or for a particular modality (e.g., x-ray, ultrasound, magnetic resonance imaging, etc.), for example. Rules may be defined by software, by a user, and/or by a system administrator, for example. New rules may be created, and/or existing rules may be modified at any time by accessing and storing the new or modified rule in the user rules database 131. The user rules and user tasks are utilized by the workflow engine 120 to determine what information is displayed in and/or with the worklist 110. The user preferences may be defined for a particular user or group of users (e.g., surgeons, radiologists, cardiologists, etc.), for example. Preferences may be defined by software, by a user, and/or by a system administrator, for example. New preferences may be created, and/or existing preferences may be modified at any time by accessing and storing the new or modified preferences in the user preferences database 132. The user preferences are utilized by the workflow engine 120 to determine how the information will be displayed in and/or with the worklist 110.

Then, at step 230, the information obtained, calculated and filtered by the workflow engine 120 is displayed on the worklist 110 based on a user login. A user initiates access to a system 100, such as an information system or clinical workstation. Access to a system may include authentication at the system and/or authentication at additional connected systems. Authentication may occur manually and/or automatically based on input or stored information.

Next, at step 240, a work item from the worklist 110 is selected by a user. For example, a radiologist clicks a button to launch lab information for a patient. Steps 210-240 are a dynamic process. For example, after user tasks are identified, the workflow engine 120 calculates and filters the user tasks, user rules, and user preferences, the workflow engine 120 the worklist 110 based on a user login, and the user acts on a work item, the user tasks database 130 will identify the updated workflow and the process will repeat.

Then, at step 250, departmental and/or enterprise information is provided to the user based on the operation selected on the work item. Thus, the user is presented with relevant, requested information. The information may be displayed for the user, stored, and/or routed to another program, for example. In an embodiment, the user may organize the information presented based on user preferences, which allows the workflow engine 120 to filter and display the information in and/or with the worklist 110 as the user prefers, for example.

Thus, certain embodiments unify a variety of departmental and enterprise information with the user's workflow. Certain embodiments filter information available to a user based on rules and preferences. Certain embodiments facilitate increased productivity of a radiologist, cardiologist, or other users whose workflow include accessing relevant departmental and enterprise information. Increased productivity includes a speed in which a diagnosis may be performed and an accuracy of reports produced based on the diagnosis.

In certain embodiments, rules and preferences allow information and workflow to be filtered. A user may store and toggle between sets of rules and/or preferences. In certain embodiments, a user may toggle between sets of rules and/or preferences without touching a keyboard or mouse using a technique such as voice command and/or gaze tracking. Alternatively, a user may toggle between rules and/or preferences using a single click from a mousing device or a button. Thus, certain embodiments allow a user to view only the information he or she wants in the workflow he or she wants.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A dynamic worklist management system, the system comprising:
a worklist user interface, wherein the worklist user interface includes a task list;
a plurality of databases capable of storing user data;
at least one data store, wherein the at least one data store includes information; and
a workflow engine for displaying a dynamically updated task list on the worklist user interface, using at least one of the user data provided in the plurality of databases and information in the at least one data store.

2. The system of claim 1, wherein the worklist user interface includes at least one of a button and a link to access information in an independent application.

3. The system of claim 1, further comprising an authentication module for authenticating access to the worklist user interface.

4. The system of claim 1, wherein the worklist user interface is capable of accessing at least one external system.

5. The system of claim 1, wherein the plurality of databases includes a user tasks database, a user rules database, and a user preferences database.

6. The system of claim 1, wherein the at least one data store includes at least one of a departmental data store and an enterprise data store.

7. The system of claim 1, wherein the workflow engine monitors and dynamically updates the worklist user interface with at least one of the user data from the plurality of databases and the information from the at least one data store.

8. A method for dynamically updating a worklist user interface, the method comprising:
dynamically identifying at least one task;
filtering and organizing the at least one task;
displaying the at least one task;
providing information based on a user selection; and
updating the at least one task based on a user selection.

9. The method of claim 8, further comprising authenticating access to the information.

10. The method of claim 8, further comprising accessing information from a plurality of sources including a plurality of departmental, enterprise, and external information sources.

11. The method of claim 8, wherein the information provided based on the user selection is at least one of departmental information and enterprise information.

12. The method of claim 8, wherein the process of identifying, filtering, and displaying the at least one task is dynamic.

13. The method of claim 8, wherein at least one user rule is used to filter the at least one task.

14. The method of claim 8, wherein at least one user preference is used to organize the at least one task.

15. The method of claim 13, wherein the at least one user rule is dynamically created or modified.

16. The method of claim 14, wherein the at least one user preference is dynamically created or modified.

17. A computer-readable storage medium including a set of instructions for a computer, the set of instructions comprising:
a user action routine for updating stored information based on user selections in a worklist user interface;
a user task routine for identifying user tasks based on dynamically updating stored information;
a workflow engine routine for filtering the user tasks identified by the identification routine; and
a worklist routine for displaying the filtered user tasks on the worklist user interface.

18. The set of instructions of claim 17, further comprising a user rules engine routine for defining rules for filtering user tasks.

19. The set of instructions of claim 17, further comprising a user preferences engine routine for defining preferences for filtering user tasks.

20. The set of instructions of claim 17, further comprising a perspectives routine for organizing the information for a user.
